(19) United States
(12) Patent Application Publication
(10) Pub. No.: US 2025/0020890 A1
(43) Pub. Date: Jan. 16, 2025

(54) Lunar Articulating Mirror Array

(71) Applicant: Blueshift, LLC dba Outward Technologies, Broomfield, CO (US)

(72) Inventors: Ryan GARVEY, Lafayette, CO (US); Alan Thomas CARTER, Arvada, CO (US); Austin Kenneth MILLER, Gold Hill, CO (US)

(73) Assignee: Blueshift, LLC dba Outward Technologies, Broomfield, CO (US)

(21) Appl. No.: 18/771,840

(22) Filed: Jul. 12, 2024

Related U.S. Application Data
(60) Provisional application No. 63/526,914, filed on Jul. 14, 2023.

(51) Int. Cl. G02B 7/183; F24S 23/71; F24S 30/00; F24S 30/425; F24S 50/20; G02B 5/09; G02B 26/08

(52) U.S. Cl. CPC G02B 7/183; F24S 23/71; F24S 30/425; F24S 50/20; G02B 5/09; G02B 26/0816; F24S 2030/11

(57) ABSTRACT

A lunar articulating mirror array system and method of use, in particular a lunar articulating mirror array for powering solar thermal processes in a lunar environment. The system redirects solar radiation using a masted heliostat array. The face of the array is composed of independently actuated concentrating mirrors which form a variable focal position Fresnel reflector. In one aspect, the lunar articulating mirror array system may redirect solar flux with controllable and selectable solar concentration ratios and may replicate any reflective optic geometry.

### CROSS-REFERENCE TO RELATED APPLICATIONS

This application is a nonprovisional patent application of and claims the benefit of U.S. Provisional Patent Application No. 63/526,914 titled “Lunar Articulating Mirror Array” filed Jul. 14, 2023, the disclosure of which is hereby incorporated herein by reference in entirety for all purposes.

### STATEMENT

This invention was made with government support under Contract Nos. 80NSSC22PA967 and 80NSSC23CA076, each awarded by the National Aeronautics and Space Administration (NASA). The government has certain rights in the invention.

### FIELD

The disclosure relates generally to a lunar articulating mirror array system and method of use, in particular to a lunar articulating mirror array for powering solar thermal processes in a lunar environment.

### BACKGROUND

Infrastructure construction on the Moon traditionally seeks to leverage the abundance of solar energy and lunar regolith. Conventional approaches range from a lunar microwave paving rover (Taylor and Meek, 2005; Clinton, 2022), polymer stabilization (Hintze et al., 2009), construction with sintered regolith bricks (Whittington and Parsapoor, 2022), extrusion-based methods (Isachenkov et al., 2021), and regolith concrete produced with the introduction of cement (Grossman, 2018). All these methods of construction have pros and cons to their implementation. Microwave- and laser-based melting of regolith does not require additional binders; however, these heating methods have high electrical power requirements which make them difficult to scale before an extensive electrical power infrastructure has been established on the Moon. Binder-based methods typically require 30% additives by weight which would need to be provided on Earth or by multi-step mining and extraction of sulfur from lunar mare deposits for regolith concrete. Solar sintering in a convective furnace is a promising method for producing regolith bricks and tiles without these electrical power and binder mass requirements, however, requires extensive robotic manipulation for collecting and conveying regolith, and then placement of the tiles. These regolith bricks and tiles also have seams between each structural component which leads to ejecta and excavation of the subsurface when exposed to plume-surface interactions unless multiple layers of tiles or a geotextile is added.

The disclosed technology addresses these limitations and improves upon the state-of-the-art. The Lunar Articulating Mirror Array (LAMA) of the disclosure enables fabrication of pressurized and unpressurized structures on the Moon including landing/launch pads, roads, blast shields, and habitats using lunar regolith as the exclusive feedstock. No additional binders are required. This is achieved through a unique solar Fresnel reflector for translating a concentrated solar spot across a regolith surface at a distance of meters to tens of meters. The system has low electrical power requirements by relying on solar-thermal energy to fuse regolith through selective solar melting and liquid-phase sintering. Materials range from a consolidated glass-ceramic with high strength to lightly sintered regolith to limit ejecta. These capabilities are enabled through a lightweight design requiring minimal to no regolith handling for single-layer structures. The optics remain distanced from the site to avoid damage from dust and nearby surface operations. LAMA marks a significant advancement over CSOTA for large solar concentrators and represents a game-changing technology for lunar surface construction.

LAMA redirects solar flux with controllable concentration ratios and can replicate any reflective optic geometry. The system will be able to supply solar energy at sufficient concentrations to power various thermal processes such as selective melting, liquid phase sintering, and vapor phase pyrolysis of regolith. The system will also be able to direct solar flux at lower concentrations to photovoltaics or rovers for power and thermal management.

The Lunar Articulating Mirror Array is composed of a solar concentrating Fresnel reflector with selectable focal position, and may be utilized in two unique areas of the lunar industry to support NASA's Artemis program:
Construction: LAMA concentrates solar energy with sufficient power density to selectively sinter and melt regolith to distances of up to 30 m for a full-scale system. Materials produced by selectively melting regolith has been proven to have properties exceeding that of terrestrial grade concrete and are sufficient for use in various horizontal structures such as landing and launch pads and roadways. Also, the system may cause liquid phase sintering on the lunar surface at lower concentration ratios and distances significantly farther than 25 m. The technology may be used to rapidly treat large areas of the lunar surface, prevent the generation of ejecta from plume-surface interactions, and mitigate dust transported by electrostatic levitation.
In-space solar management: LAMA may replicate any spherically or parabolically concentrating reflective optic through a variable geometry Fresnel reflector and allows for the system to redirect solar energy at controllable concentration ratios. Processes requiring high temperatures are thus able to make use of highly concentrated energy, and photovoltaics make use of lower solar concentrations while benefiting from the increased power generation efficiencies at greater than 1 Sun concentration. Additionally, the system may illuminate and track equipment, such as rovers, operating in the permanently shadowed regions for power and thermal considerations. Lastly, equipment which becomes shadowed due to the lunar diurnal cycle, seasonal variations, or new lunar constructions may be illuminated by LAMA to facilitate continuous operations.

NASA applications include construction of large horizontal structures, layer-wise additive construction, treatment of regolith surfaces to minimize ejecta from PSI's, and solar-thermal power generation on the lunar surface. LAMA may provide a robust construction tool for addressing NASA's needs for establishing permanent lunar infrastructure while relying on abundant solar-thermal power and ISRU materials.

Potential non-NASA applications include: increased pointing accuracy of heliostat fields for higher efficiency concentrated solar-thermal power plants on Earth; improved design of heliostat geometries to enable higher temperature solar-thermal reactors for industrial decarbonization; and In-Space Servicing, Assembly, and Manufacturing (ISAM) in low-Earth orbit for DoD and commercial customers.

Compared to the current state of the art being developed for lunar construction, the LAMA system provides numerous benefits/complements, e.g.:
High strength construction material from in-situ resources and energy. Concentrated Solar Energy (CSE) is used to produce specimens with high compression strength, ductility, and toughness comparable to terrestrial concrete using lunar highlands simulant and a full melt process. This material will be produced from in situ regolith and readily available solar energy.
Rapid construction rates. Considering the divergence of incoming solar radiation, the power density and time to melt lunar highlands regolith observed in similar solar melting processes, and material handling requirements, the LAMA system will construct a Moon-to-Mars Planetary Autonomous Construction Technologies (MMPACT) Demonstration Mission DM-2 landing/launch pads (LLP) in less than 2.5 Earth days.
In situ process monitoring. The system performs the process on the construction surface. Optical imaging of the construction surface may be obtained prior and following exposure to CSE. Image analysis is then performed to verify proper fusion and densification of the regolith. The hot spot also moves at a slow enough rate to allow for easy monitoring of the melt pool emissions, and optical thermography will be able to verify proper process temperatures.
Protected optics. The LAMA places the Fresnel reflector on a mast at elevations up to 15 m. The sensitive optics are raised above dust clouds generated by nearby surface operations and electrostatic levitation (See, e.g., “The Lunar Dust Environment” by Grün et al, Planet. Space Sci., vol. 59, no. 14, pp. 1672-1680, 2011, incorporated by reference in entirety for all purposes.)
   In addition, the system has several secondary benefits, e.g.:
The resulting construction material produced by the lunar regolith is easily repairable by LAMA.
Surface cracks may be able to be remelted and healed following resolidification.
The system also requires no consumable materials from earth. Almost all terrestrial additive fully melted processes, such as selective laser melting, require a build plate onto which material is deposited. However, the process has already been proven capable of producing fully melted parts on a bed of regolith while using no additives and minimal beneficiation.
Lastly, the LAMA system is able to redirect solar radiation from higher elevations and with controllable concentrations. While deployed at the lunar poles, the LAMA system is able to escape shadows generated by geological features or new surface constructions by extending vertically. That solar energy can be concentrated for continued construction or projected at a lower concentration onto shadowed photovoltaics.

### SUMMARY

A lunar articulating mirror array for powering solar thermal processes in a lunar environment is described. The system redirects solar radiation using a masted heliostat array. The face of the array is composed of independently actuated concentrating mirrors which form a variable focal position Fresnel reflector. In one aspect, the lunar articulating mirror array system may redirect solar flux with controllable and selectable solar concentration ratios and may replicate any reflective optic geometry.

In one embodiment, an articulating mirror array system is disclosed, the system comprising: a body comprising a body face; a set of mirror elements forming a mirror array, each mirror element attached to the body face and configured to receive an input light pattern and reflect the input light pattern to produce a mirror element output light pattern; a set of mirror actuators, to articulate a respective mirror element about at least one axis to direct the respective mirror element output light pattern to a common spot location; a body actuator configured to articulate the body about at least one axis; a processor; and a controller in communication with the processor and configured to control the body actuator, the set of mirror actuators, and a selectable solar concentration ratio of each mirror element output light pattern; wherein: the controller controls the set of mirror actuators to articulate the respective mirror element to direct the respective mirror element output light pattern with an azimuth angle, an elevation angle, and a solar concentration ratio to the common spot location; the controller controls the set of mirror actuators to produce a set of mirror output light patterns, each mirror element light pattern having a common focal position at the common spot location; and the common spot location is irradiated by the set of mirror output light patterns.

In one aspect, the system further comprises a body mast coupled to the body and configured to position the body at a selected elevation above the ground. In another aspect, the body actuator operates to articulate the mirror array to track the input light pattern. In another aspect, the input light pattern is provided by the Sun and the mirror elements are parabolic mirrors. In another aspect, the set of mirror actuators comprise at least two mirror actuators for each mirror element that operate to rotate each mirror element about a local mirror element horizontal axis. In another aspect, the common spot location enables at least one of sintering and power generation. In one aspect, the system further comprises a body sensor coupled to the body, the body sensor measuring at least one of an input solar irradiance of the input light source and a location of the input light source. In another aspect, the system further comprises a common spot location sensor positioned adjacent the common spot location and measuring at least one of a common spot location temperature, a common spot location focal spot shape, a common spot location light intensity distribution, and a phase change of material. In another aspect, the system further comprises a set of backlash mitigation devices, at least one backlash mitigation device engaged with each mirror element of the set of mirror elements and operating to prevent backlash of the mirror element during mirror actuator operation.

In another embodiment, a method of using an articulating mirror array system is disclosed, the method comprising: providing an articulating mirror array system comprising: a body comprising a body face; a set of mirror elements forming a mirror array, each mirror element attached to the body face and configured to receive an input light pattern and reflect the input light pattern to produce a mirror element output light pattern; a set of mirror actuators, each mirror actuator configured to articulate a respective mirror element about at least one axis to direct the respective mirror element output light pattern to a common spot location; a mirror element sensor to measure a rotation between each mirror element and the body face; a body actuator configured to articulate the body about at least one axis; a processor; and a controller in communication with the processor and configured to control the body actuator, the set of mirror actuators, and a selectable solar concentration ratio of each mirror element output light pattern; orienting the body to receive the input light pattern; receiving the input light pattern at each of the set of mirror elements; actuating, by the controller, each of the set of mirror actuators to articulate the respective mirror element to direct the respective mirror element output light pattern with an azimuth angle, an elevation angle, and a solar concentration ratio to the common spot location; controlling, by the controller, the set of mirror actuators to produce a set of mirror output light patterns, each mirror element light pattern having a common focal position at the common spot location; and irradiating the common spot location by the set of mirror output light patterns.

In one aspect, the method further comprises the step of tracking the input light pattern with the mirror array by actuating the body actuator as the input light pattern changes source position. In one aspect, the articulating mirror array system of the method further comprises a sensor placed adjacent the common spot location to monitor at least one of a common spot position, a solar flux density distribution, a common spot light intensity distribution, a temperature, and a phase change of material. In one aspect, the input light pattern is provided by the Sun. In another aspect, the mirror elements are parabolic mirrors. In another aspect, the common spot location enables at least one of sintering and power generation. In another aspect, the set of mirror actuators comprise at least two mirror actuators for each mirror element that operate to rotate each mirror element about a local mirror element horizontal axis. In one aspect, the articulating mirror array system of the method further comprises a set of backlash mitigation devices, at least one backlash mitigation device engaged with each mirror element of the set of mirror elements and operating to prevent backlash of the mirror element during mirror actuator operation. In one aspect, the articulating mirror array system of the method further comprises a body mast coupled to the body and configured to position the body at a selected elevation above the ground. In one aspect, the articulating mirror array system of the method further comprises a body sensor coupled to the body, the body sensor measuring at least one of an input solar irradiance of the input light source and a location of the input light source.

In yet another embodiment, an articulating mirror array system is disclosed, the system comprising: a body comprising a body face; a set of mirror elements forming a mirror array, each mirror element coupled to the body face and configured to receive an input light pattern and reflect the input light pattern to produce a mirror element output light pattern; a set of mirror actuators, each mirror actuator configured to articulate a respective mirror element about at least two axes to direct the respective mirror element output light pattern to a common spot location; a set of backlash mitigation devices, at least one backlash mitigation device engaged with each mirror element of the set of mirror elements; a body actuator configured to articulate the body about at least one axis; a processor; and a controller in communication with the processor and configured to control the body actuator, the set of mirror actuators, and a selectable solar concentration ratio of each mirror element output light pattern; wherein: the input light pattern is provided by the Sun; the mirror elements are parabolic mirrors; the set of mirror actuators comprise at least two mirror actuators for each mirror element that operate to rotate each mirror element about a local mirror element horizontal axis; the set of backlash mitigation devices prevent backlash of each of the mirror elements during mirror actuator operation; the controller controls the set of mirror actuators to articulate the respective mirror element to direct the respective mirror element output light pattern with an azimuth angle, an elevation angle, and a solar concentration ratio to a common spot location; the controller controls the set of mirror actuators to produce a set of mirror output light patterns, each mirror element light pattern having a common focal position at the common spot location; and the common spot location is irradiated by the set of mirror output light patterns.

By way of providing additional background, context, and to further satisfy the written description requirements of 35 U.S.C. § 112, the following set of references are incorporated by reference in entirety: U.S. Pat. No. 7,192,146 entitled “Solar concentrator array with grouped adjustable elements” to Gross; U.S. Pat. No. 9,995,507 entitled “Systems for cost-effective concentration and utilization of solar energy” to Norman; U.S. Pat. No. 10,768,398 entitled “Solar-concentrating solarization apparatus, methods, and applications” to Lal; U.S. Pat. No. 7,834,303 entitled “Multi-element concentrator system” to Fatehi; and U.S. Pat. No. 9,995,507 entitled “System for Cost Effective Concentration and Utilization of Solar Energy” to Norman; US Patent Application Publication Nos. 2014/0261387 entitled “Concentrating solar collector and pre-formed Fresnel array reflector panel” to Hansen and 2010/0294266 entitled “Concentrated Solar Thermal Energy Collection” to Fung; WIPO Publ. No. WO2017016550 entitled “Method and device for the thermal treatment of sand” to Frank; European Patent Document No. EP 2,799,794 entitled “Apparatus for Concentrating Energy” to Komrakov; and “Commercial lunar propellant architecture: A collaborative study of lunar propellant production” published March 2019 in Reach, Volume 13.

The term “regolith” means any blanket of unconsolidated, loose, heterogeneous superficial deposits that covers solid rock, and may include soil, dust, broken rocks, and other related materials. Regolith is present at least on Earth, the Moon, Mars, and some asteroids.

The term “heliostat” is a device that includes a mirror which turns so as to keep reflecting sunlight toward a predetermined target, compensating for the sun's apparent motions in the sky.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The disclosed methods and/or systems may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as programs embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The disclosure will be readily understood by the following detailed description in conjunction with the accompanying drawings, wherein like reference numerals designate like elements. The elements of the drawings are not necessarily to scale relative to each other. Identical reference numerals have been used, where possible, to designate identical features that are common to the figures.

FIG. 1 depicts one embodiment of a lunar articulating mirror array system;

FIG. 2 is a flow chart of a method of use of the lunar articulating mirror array system of FIG. 1;

FIG. 3A is a front view of portions of another embodiment of a lunar articulating mirror array system;

FIG. 3B is a side view of the embodiment of a lunar articulating mirror array system of FIG. 3A;

FIG. 3C is a top view of the embodiment of a lunar articulating mirror array system of FIG. 3A;

FIG. 4 is flow chart of additional details of some aspects of the method of use of FIG. 2 of the lunar articulating mirror array system;

FIG. 5A depicts a side-view of a fifteen mirror element lunar articulating mirror array system;

FIG. 5B depicts a front, perspective view of the fifteen mirror element lunar articulating mirror array system of FIG. 5A;

FIG. 6A is an orthogonal view of one embodiment of the mirror and actuator assembly of a lunar articulating mirror array system;

FIG. 6B is another orthogonal view of the embodiment of the mirror and actuator assembly of FIG. 6A;

FIG. 6C is a side-view of the embodiment of the mirror and actuator assembly of FIG. 6A;

FIG. 6D is a side-view of the embodiment of the mirror and actuator assembly of FIG. 6A;

FIG. 7A is an assembly diagram of a protype lunar articulating mirror array system; and

FIG. 7B is a close-up front perspective of a portion of the lunar articulating mirror array system of FIG. 7A.

It should be understood that the proportions and dimensions (either relative or absolute) of the various features and elements (and collections and groupings thereof) and the boundaries, separations, and positional relationships presented there between, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments. The following descriptions are not intended to limit the embodiments to one preferred embodiment. To the contrary, it is intended to cover alternatives, modifications, and equivalents as can be included within the spirit and scope of the described embodiments as defined, for example, by the appended claims.

The fully melted and liquid-phase sintered regolith materials which may be produced by LAMA possess a highly attractive combination of traits for lunar surface construction. The LAMA concept uses a readily available solar thermal heat source for driving the melting and fusing of lunar regolith. This solar power may be projected onto the regolith from a distance, thereby minimizing regolith handling and site preparation requirements. Large horizontal and multi-layer structures may be fabricated from minimally beneficiated lunar highlands or mare regolith without additional binder materials from Earth. The electrical power consumption of LAMA is negligible as compared to alternative heating methods such as microwave and laser. All of these capabilities are made possible through a lightweight, stowable, fault-tolerant design with minimal maintenance requirements that is optimally suited for long term operation in the harsh lunar environment. The collection of dust on the mirror elements and gradual damage to the mirror finish due to abrasion and wear by the regolith are one possible failure mode of LAMA, however the impact of dust on the optics is minimized due to their vertical orientation and elevated position above the ground surface.

Further, by deploying LAMA as one of the first hardware assets at the location of a future human settlement or lunar outpost, the surrounding area of ground may be treated by LAMA to form a stabilized regolith surface much less prone to generating dust during continued surface operations, thereby greatly minimizing the impact that dust has on LAMA's own performance and on any co-located lunar surface assets. The mirrors themselves reflect most of the sunlight on the mirror front face and the mirror backside is facing shadow, therefore reducing their required maximum operating temperature and minimizing thermal cycling. For all of these attractive features, the proposed LAMA system represents one of the most capable and versatile options available to NASA for its development of permanent infrastructure on the Moon by enabling the construction of large horizontal regolith structures, the repair of these structures through remelting of spalled material and thermal healing of cracks, treatment of expansive areas of ground for mitigating dust, additive construction of multi-layer structures with the support of a rover or other supportive robotic hardware for regolith handling and deposition, and efficient collection and transmission of solar energy for solar-thermal and electrical power generation on the lunar surface.

Generally, a Lunar Articulating Mirror Array (LAMA) for constructing roads, landing/launch pads (LLPs), non-pressurized structures, and surfaces mitigated against dust on the lunar surface is disclosed. LAMA redirects solar radiation using a masted heliostat array with a solar collector area measuring approximately 100 m². The face of the array is composed of articulating parabolic concentrating mirrors to form a variable focal length Fresnel reflector.

The mirror articulation allows for the array to translate a concentrated solar spot across a horizontal regolith surface and produce a molten regolith pool from distances of between 3.5 m to 30 m from the array. Lower concentrations and faster translation speeds of the concentrated solar spot produce lightly sintered surfaces to mitigate against dust generation, while fully melted and solidified regolith may serve as horizontal structures such as LLPs and roadways.

The system makes use of in situ process monitoring technologies being developed for terrestrial additive processes, such as melt pool emissions monitoring and image analysis of solidified layers, for process verification and qualification (See “In-situ measurement and monitoring methods for metal powder bed fusion: An updated review,” by Grasso et al, Meas. Sci. Technol., vol. 32, no. 11, 2021, incorporated by reference for all purposes.)

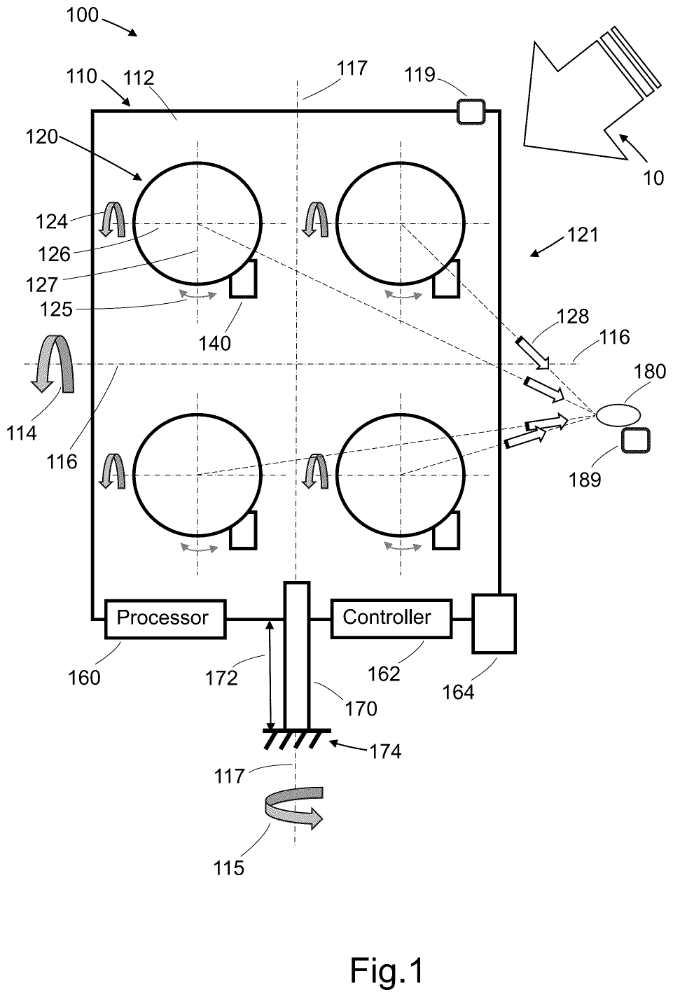

The disclosed devices, systems, and methods of use will be described with reference to FIGS. 1-7B. Generally, systems and methods to provide a lunar articulating mirror array system and method of use are provided. The term “system” or “LAMA” may be used to refer to an embodiment of the lunar articulating mirror array system. The term “method” may be used to describe an embodiment of a method of use of the lunar articulating mirror array system.

Although the disclosed devices, systems, and methods of use will be principally described relative to a lunar articulating mirror array system for use in lunar applications, the devices, systems, and methods of use have other applications. For example, the method and/or devices may be used in terrestrial applications such as solar power generation. Other applications or uses are possible.

The phrase “light pattern” refers to all characteristics of an emitted light, such as brightness, profile angle, color, pixilation, etc. The phrase “light profile” refers to the angle of the emitted cone of light; light profile is one characteristic of a light pattern.

The term “sintering” means the process of forming a solid mass of material by heat without melting the material to the point of liquefaction and may include solid state sintering where no melting occurs or liquid phase sintering where an additive is melted to draw unmelted particles towards one another and bond them together.

The phrase “NASA sintering” means the process of melting <50% of regolith to bond the rest of the unmelted regolith together.

The term “melting” means the process of forming a liquid mass of material by heating a portion or all of the material to the point of liquefaction.

The phrase “additive manufacturing” or “AM” means a process that involves production of a component through successive additions of layers, which is the opposite of traditional subtractive manufacturing, where parts and pieces are removed during construction of a product.

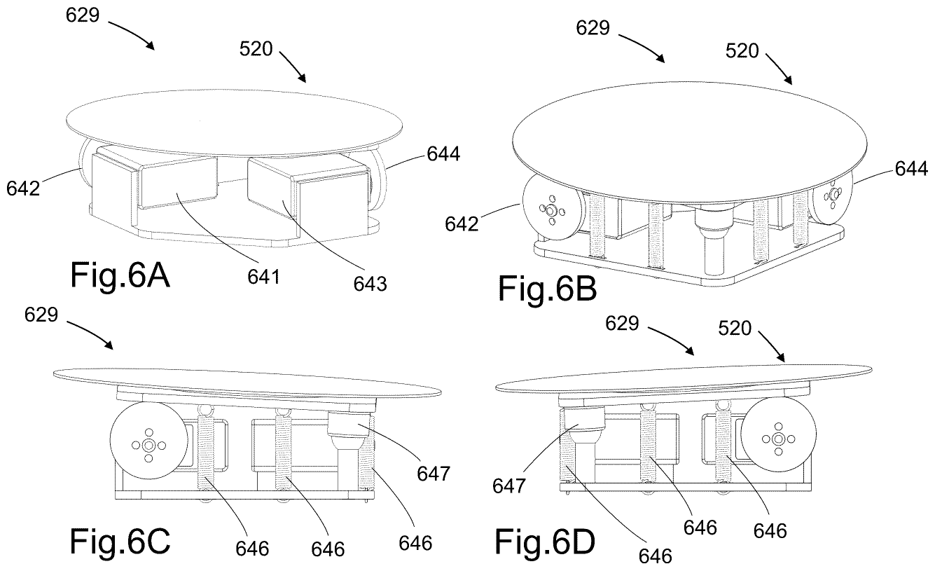

With attention to FIG. 1, one embodiment of a lunar articulating mirror array system 100 is described. Most generally, the lunar articulating mirror array system 100 comprises a body 110 with a body face 112, a set of mirror elements 120 forming a mirror array 121 attached or coupled or engaged with the body 110 such as the body face 112, a set of mirror actuators 140, a body mast 170, a body actuator 164, a processor 160 and a controller 162. Each of the set of mirror elements 120 (there are four in total in the embodiment of FIG. 1) operate to receive an input light pattern 10 (such as from the Sun) and reflect the input light pattern 10 to produce a mirror element output light pattern 128 (one such mirror element light pattern 128 is produced from each of the mirror elements 120). Each of the set of mirror actuators 140 (there is one set of mirror actuators 140 for each of the mirror elements 120) operate to articulate the respective mirror element 120 to direct the respective mirror element light pattern 128 to a common spot location 180. In some embodiments, such as those of FIGS. 6A-D and 7A-B), more than one actuator operates or engages with each mirror element. In some embodiments, one or more actuators are shared between multiple mirror elements. Stated another way, the LAMA consists of an articulating array of reflective parabolic mirror elements (or other types or configurations of mirror elements) installed on an extendable mast. The system orients the body face relative to the sun location and common spot location by adjusting a rotational joint at the base of the mast-rover junction or at the mast-array junction as well as optionally the angle of inclination of the plurality of mirrors composing the mirror array. While translating the common spot location, the system adjusts orientation of each mirror element to control focal length and to maintain the concentrated solar spot at the common spot location on the target surface. The orientation of each mirror element is adjusted by a ganged assembly, or by two or more independent actuators mounted on each mirror element. Each of the set of mirror elements may be operated or controlled to provide a selectable solar concentration ratio and/or focal position. The set of mirror elements may operate such that each present a common focal point at the common spot location.

As non-limiting embodiments, two methods of determining desired focal length may be implemented: 1) open loop control considering concentrator position and topological survey information of the construction site, and 2) closed loop control considering image processing of, and emissions from, the melt pool and/or considering the true orientation of each mirror relative to the body face and common spot location.

Mirror elements (in one embodiment, parabolic mirror elements) provide primary solar concentration and simplify actuation of the system by reducing the total number mirror elements required for melting regolith (or other materials) as compared to flat mirror elements.

Applications of LAMA include projecting sunlight onto the ground at high solar flux densities (e.g., greater than 1 W/mm²) to sinter and melt lunar regolith. This enables the fusing of lunar soil to form glass ceramic structures whose strength is comparable to concrete and rock. This enables the construction of lunar launch and landing pads, along with the stabilization of lunar regolith surfaces to prevent the lofting of dust which is a major problem for lunar surface operations. Lower power densities and higher scan speeds across the surface enables lower levels of melting which produces a lightly sintered surface structure for entraining dust within a consolidated surface layer. Large areas of ground may be treated in this fashion which is likely a primary use case for LAMA. Multi-layer structures may be formed through deposition of new regolith material in a layerwise additive manufacturing/construction process.

The body 110 is configured to secure the set of mirror elements 120 and the respective mirror actuator 140 of each mirror element. The body face 112 of the body 110 is configured to receive or secure the set of mirror elements 120 and the respective set of mirror actuators 140 of each mirror element. The body 110 and the body face 112, and thus the set of mirror elements 120 in entirety (that is, as a unit or as the entire mirror array 121), may rotate about one or both of the vertical axis 117 (akin to a yaw or azimuth rotation) and about the horizontal axis 116 (akin to a pitch or an elevation rotation). The rotation of the body 110 and body face 112 along the vertical axis 117 may be about the centerline axis of the body mast 170. The one or more rotations of the body 110 and body face 112 are enabled by the body actuator 164. The body actuator 164 is configured to articulate the body 110 and body face 112 about the axis 117 and/or the axis 116. In some embodiments, the body actuator is configured to articulate the body 110 and/or body face 112 about at least two axes. Note that because the mirror array 121 is attached to or secured to or coupled to the body 110 and/or the body face 112, a rotation or any movement of the body and/or body face by the body actuator 164 in turn rotates or moves the mirror array 121. For example, in one embodiment, the body actuator 164 operates to articulate the mirror array 121 to track the input light pattern 10. In one embodiment, a flexible textile mesh is configured to support or hold or engage one or more of the mirror elements.

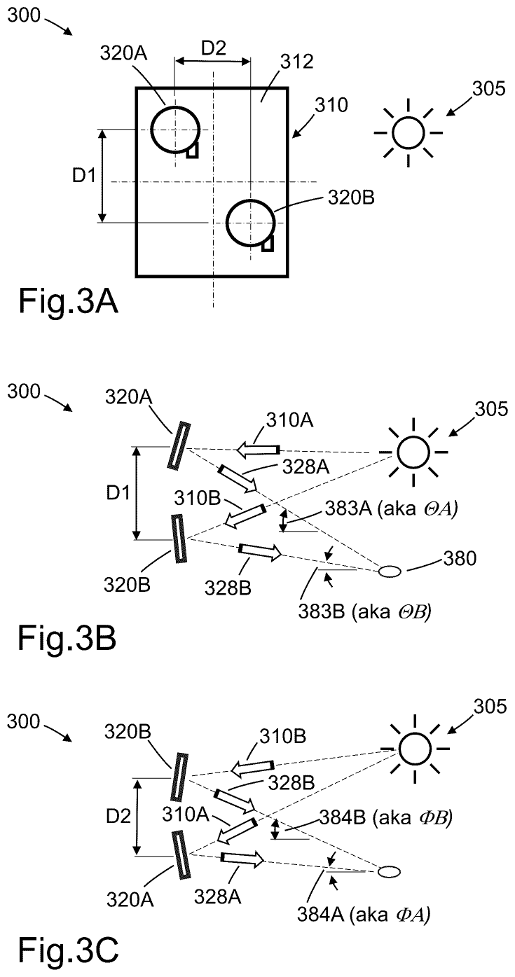

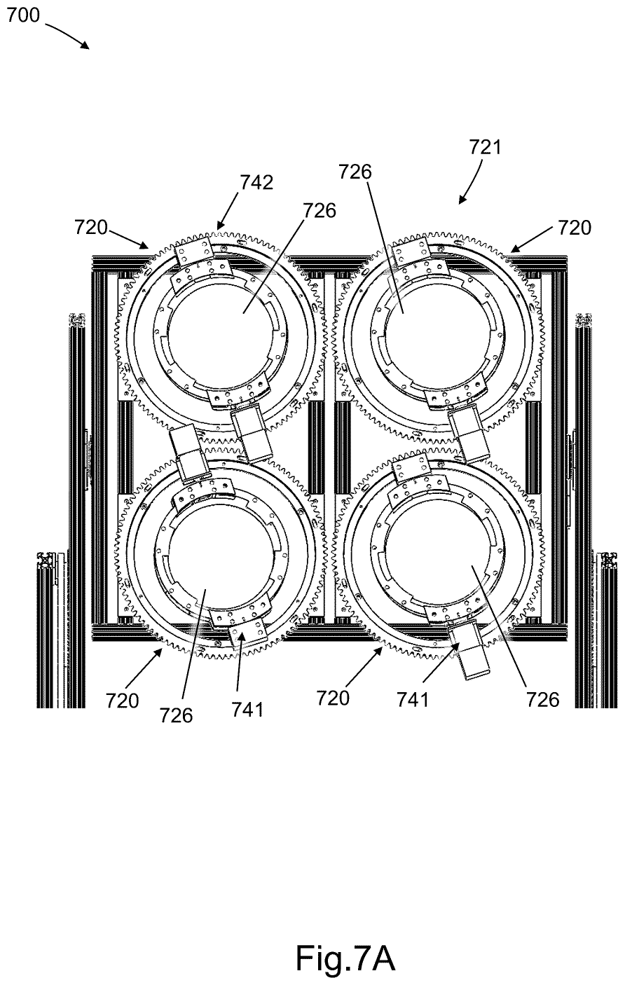

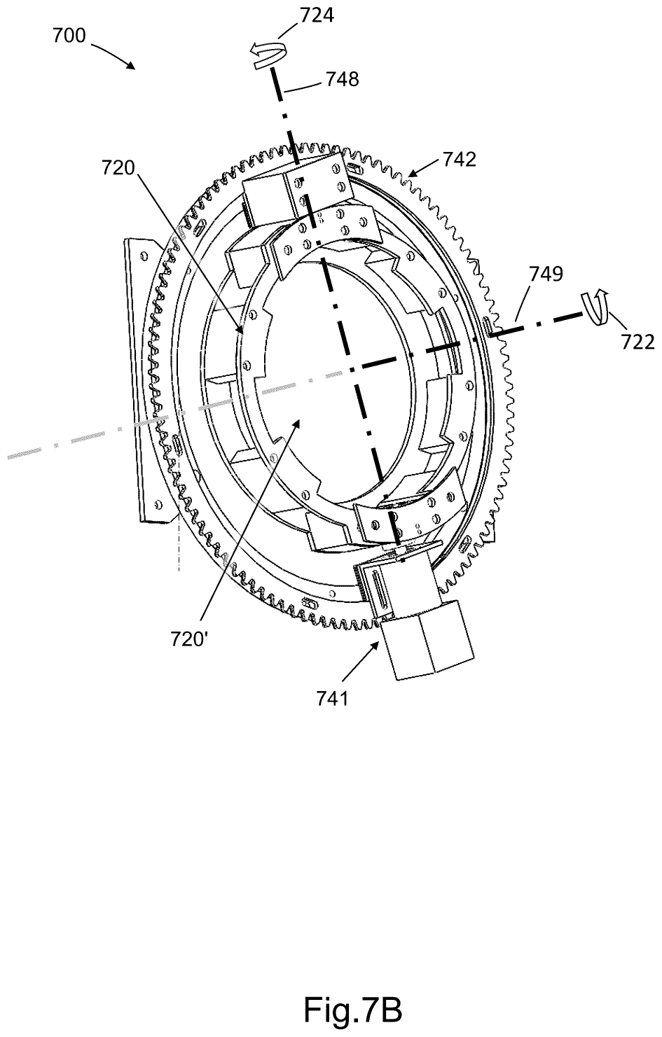

Each set of mirror actuators 140 is configured to articulate a respective mirror element 120 about one or both of a local mirror horizontal axis 126 (a “tilt” axis) and a normal axis relative to the mirror (a “twist” axis). Stated another way, the mirror actuator(s) operates to provide a local horizontal rotation 124 of a respective mirror element 120 about a local horizontal axis 126 and/or to provide a local twist rotation 125 of a respective mirror element 120 about a local normal to the mirror. (See FIG. 11 as to tilt and twist operations of a mirror element, depicting a tilt rotation 724 about axis 726 and a twist rotation 725 about axis 722). The result of the “tilt and twist” configuration of FIG. 7B is a mirror element that may be oriented to project or reflect an incoming or received input light pattern to produce a mirror element light pattern along a path or vector of a determined or controllable or selectable azimuth angle ϕ and elevation angle θ, and to thus direct that mirror element light pattern to the common spot location. (See FIGS. 3B-C as to selectable azimuth angle ϕ and elevation angle θ).

In an alternate embodiment, the mirror elements operate in a “tip and tilt” configuration, as shown in FIGS. 6A-D. The ultimate (optical) result of the “tip and tilt” configuration is identical to that of the above “tilt and twist” configuration: the mirror element is oriented to project or reflect an incoming or received input light pattern to produce a mirror element light pattern along a path or vector of a determined or controllable azimuth ϕ and elevation angle θ, and to thus direct that mirror element light pattern to the common spot location. (See, e.g., FIGS. 3B-C).

Other configurations of mirror actuation and control are possible, to include a “tilt and yaw” configuration in which a mirror element operates to rotate about the local mirror horizontal axis 126 (a “tilt” axis) and also to rotate about a local mirror vertical axis 127. Again, as with the above two mirror element actuation/control configurations or embodiments, the result of the “tilt and yaw” configuration is a mirror element that may be oriented to project or reflect an incoming or received input light pattern to produce a mirror element light pattern along a path or vector of a determined or controllable azimuth ϕ and elevation angle θ, and to thus direct that mirror element light pattern to the common spot location.

Note that although the above mirror element actuation/control configurations or embodiments describe one mirror element, in practice such configurations would typically be applied to a set of mirror elements which create a mirror array.

In some embodiments, the mirror elements forming a mirror array are configured in different actuation/control configurations, e.g., a first set of mirror elements are configured in a “tilt and twist” configuration and a second set are configured in a “tip and tilt” configuration. In some embodiments, a given mirror actuator 140 operates or actuates more than one mirror element 120. In some embodiments, each mirror element is engaged with an actuator in any configuration that enables the mirror element to adjust each of elevation and azimuth angle.

Various combinations of actuators, mirror elements, and degrees or freedom (“DOF”) of the mirror elements are possible. In one embodiment, a single actuator is configured to operate a particular mirror in one DOF, such as one axis of rotation, and more generally one actuator is required or fitted for each DOF of each mirror element. In another embodiment, a single actuator is configured to operate a particular mirror in more than one DOF, such as in two axes. In one embodiment, a single actuator is configured to actuate or operate more than one mirror element, such as a plurality of mirror elements in the same or different DOF (e.g., the same or different axes of rotation). In one embodiment, a plurality of actuators is required to actuate or operate a mirror element in one DOF, such as in one axis of rotation. In one embodiment, a “ganged array” configuration, a single actuator is used to actuate multiple mirror elements in the same DOF, such as about a common axis of rotation. Generally, the use of one dedicated actuator per mirror element and per DOF of that mirror element (e.g. two dedicated actuators to provide two axes of rotation for a particular mirror element) provides relatively increased flexibility, pointing accuracy, and solar flux. Note that the terms “actuator” and “motor” mean a component of a machine that produces force, torque, or displacement, usually in a controlled way, when an input, such as an electrical, pneumatic or hydraulic input, is supplied to it in a system.

The body mast 170 is attached or secured to the ground 174, which in lunar applications is the lunar surface. The body 110 is secured or positioned relative to the ground at an elevation distance 172. In some embodiments, the elevation distance 172 may be adjustable or selectable through means known to those skilled in the art, such as by a telescoping mast that is extendable to raise or lower the elevation distance 172. In some embodiments, the mast is an unrolling member which is rigid following deployment. In some embodiments, the mast is an inflatable rigidizable (meaning may become rigid) textile.

The input light pattern 10 may be provided by the Sun. The input light pattern 10 is received by the set of mirror elements 120 of the mirror array 121 and is reflected and altered in direction and/or optical character (e.g., focal position, solar concentration ratio, etc.) to form a set of mirror element output light patterns 128. Each of the set of mirror element output light patterns 128 are directed or reflected to the common spot location 180. The common spot location 180 is irradiated by the set of mirror element output light patterns 128.

One or more body sensors 119 may be coupled to or attached to the body 110 and/or the body face 112. A body sensor 119 may measure one or more of: incoming solar irradiance, solar source location, target (aka the common spot location) temperature, common spot light intensity distribution, focal spot shape, and light intensity distribution across the target. In one embodiment, a body sensor measures the rotation of each mirror element relative to the body face.

A common spot location sensor 189 may be located adjacent or near the common spot location to measure one or more of: target (aka the common spot location) temperature, focal spot shape, and light intensity distribution.

In one embodiment, an optical sensor such as a CCD camera is mounted onto the LAMA body or on hardware located adjacent to the target surface. The optical sensor may be used to monitor the target surface to measure intensity of reflected light. A light intensity profile may be generated for the target surface to infer solar flux density distribution at and near the common spot location. The inferred solar flux density distribution profile may then be used to adjust the pointing of individual mirror elements to improve mirror alignment and increase the peak solar flux density or otherwise adjust the distribution of solar flux density at the common spot location. The optical sensor may also be used to compare the intended common spot location and measured reflected light intensity profile at the target surface to adjust the pointing of the array to better align the common spot location with the intended spot location. The optical sensor may further be used to calibrate the orientation of individual mirror elements and map their rotations to a cartesian coordinate system overlaid onto the target surface.

Each mirror element 120 may be of any of several configurations or design, to include e.g., a flat or concave optical profile, for producing primary solar concentration. In some embodiments, the mirror elements have a spherical or parabolic shape with a far focal point several meters in distance. The mirror elements may be made from, e.g., rigid, thin-film, and/or inflatable materials.

The processor 160 and/or controller 162 operate to control the set of mirror actuators 140, the body actuator 164, the body sensor 119, and the common spot location sensor 189.

The processor 160 and/or controller may be configured to control and/or monitor system aspects of the lunar articulating mirror array system, to include, e.g., incoming solar irradiance, solar source location, target temperature, and focal spot shape.

The processor 160 and/or controller 162 may operate to, e.g., adjust mirror element orientation to vary the target location of the solar concentrator, control the orientation of each mirror element to produce a controllable solar flux density spot profile at the target location, rotate the mirror array about the longitudinal axis of mast or vertical tower to roughly track motion of the Sun, rotate the mirror array about a horizontal axis of mast or vertical tower to reduce cosine losses for receiver targets near the base of the array, employ the mirror array to perform selective melting of the target surface, direct the reflected light (i.e., direct the output light pattern) of each mirror element to a selectable and controllable azimuth ϕ and elevation angle θ relative to the common spot location, provide or produce a selectable solar concentration ratio of the output light pattern for each mirror element, provide or produce a selectable focal point, and/or employ the mirror array to perform selective liquid phase sintering of the target surface.

The common spot location 189 aka the irradiating location is the location at which irradiation of any working material occurs. The irradiation (or more generally the concentrated energy focused on the location) may be used for a variety of purposes, to include, e.g., sintering and power generation.

Actuation of the mirror elements may take many forms. One lightweight low power actuation mechanism is the motorized cam configuration shown in FIGS. 6A-D. Backlash prevention is provided through one or more backlash mitigation devices such as springs mounted to each mirror element. (The term “backlash” or “lash” or “slop” or “play” means a clearance or lost motion as caused by gaps between parts, such as clearance between mated gear teeth or in a gear train component). Feedback and control of the positioning of each mirror element enables precise directivity of each output light pattern to the common spot location. Due to the long focal distances and variable ranges of operation, the control may be a closed loop control system. Machine vision may be employed to study the flux density distribution of the combined concentrated solar spot to converge, diverge, or otherwise control positioning of individual mirror elements. Several control schemes may be employed that provide precise positioning of the mirror elements and the overall configuration of the array. Feedback may also be employed at the intended spot location such as in the cases of the powering of a fixed reactor. Position sensing of the mirror elements may also be employed at or near the system to monitor relative rotation of each mirror element relative to the body face, sun position, and common spot location.

Additional feedback may be added to monitor the thermochemical process being powered by LAMA. This can include temperature, temperature distribution, temperature history, liberated gases, and determination of material phase of the heated target.

In one application, the lunar articulating mirror array system is used for construction on a lunar landing surface. A mirror array of a lunar articulating mirror array system is used to direct solar energy to a common spot location to translate across the lunar surface to fuse lunar soil to create a lunar landing pad. The lunar articulating mirror array system may have a payload with a solar collection area of 3 m×3 m mounted onto a Commercial Lunar Payload Services (CLPS) lander.

Such a lunar articulating mirror array system may have a vertically oriented heliostat array composed of independently actuated parabolic mirror elements which produce a solar Fresnel reflector with selectable focal position. This unique optomechanical design enables sunlight to be concentrated and projected at greater than 85% optical efficiency to one or more locations on the lunar surface. This highly concentrated solar spot may then be translated across the lunar surface in a process of selective solar melting and liquid-phase sintering of regolith. The very high concentration ratios (>1,000 suns) produced by the lunar articulating mirror array system fuses regolith to form a cohesive layer ranging from a dendritic surface structure to a thick consolidated layer of regolith whose strength is greater than concrete. These activities are performed by the lunar articulating mirror array system at a distance of meters to tens of meters from the construction, require no binders or other consumables from Earth, require minimal to no site preparation prior to construction, and require only nominal levels of electrical power by instead relying on the abundant solar power on the Moon to drive the solar-thermal heating, melting, and fusing of regolith structures.

The innovative design of the LAMA technology enables high solar flux densities (e.g., >1 W/mm²) to be concentrated onto a spot several meters to tens of meters from the solar concentrating array. These high solar flux densities at the concentrated spot provide enough heat to the regolith to induce both liquid-phase sintering for surface stabilization treatments and full melting for constructing large horizontal structures made from regolith. Following these activities, LAMA may provide abundant solar-thermal power to oxygen extraction reactors or lower magnitude solar flux densities can be transmitted across a distance of up to hundreds of meters for powering photovoltaics and providing low levels of heat to other lunar surface assets.

Principally, the LAMA system enables construction of large horizontal structures and dust mitigation treatments on the lunar surface while requiring minimal or no site preparation, nominal levels of electrical power, and no binders or other consumables from Earth. A cohesive surface structure is formed by selective solar liquid-phase sintering which prevents lunar dust from being lofted during plume-surface interactions or by electrostatic levitation. A consolidated glass-ceramic material is formed for selective solar melting of regolith which, at the solar flux densities obtainable by the LAMA system, cools to form a high strength material with greater flexural strengths and toughness than concrete. With increased system complexity, construction of multi-layer regolith structures also becomes possible with LAMA through added robotic manipulation by a supporting rover to deposit new layers of regolith atop the growing structure.

The innovative design of the LAMA technology leads to efficient (that is, for example, greater than 85% optical transmission efficiency) and continuous high temperature processing of lunar regolith enabling several key capabilities for constructing lunar infrastructure and establishing a permanent human presence on the Moon. These unique capabilities provided by LAMA become possible through a lightweight, versatile, and durable design requiring minimal electrical power for near-term deployment on the Moon.

Embodiments of the articulating mirror array system may comprise various configurations of mirror elements. For example, a four-mirror element lunar articulating mirror array system and a 900-mirror element lunar articulating mirror array system.

In one aspect of the 900-mirror element lunar articulating mirror array system, the system collection area measures 3 m×3 m and may be mounted onto a CLPS lander. Furthermore, such a configuration may produce 1 W/mm² of solar flux density for selective solar melting and sintering of regolith at distances of between 1 m to 9 m from the mirror array and produce an average spot size of 72 mm in length and 54 mm in width. The system may be capable of selective solar melting of lunar highlands regolith at, e.g., a scan speed of 9 mm/s and hatch spacing of 41 mm for a construction rate of 0.7 m²/hour. This LAMA system is capable of constructing an LLP similar in size to the MMPACT DM-2 with diameter of 7.6 m in as little as 62.4 hours without repositioning the array.

In embodiments of a large-scale LAMA system measuring 10 m×10 m, an effective working range for the array produced flux densities projected onto the lunar surface that exceeded 1 W/mm². Averaging the spot size at each of these points gives a spot 15.5 cm in length and 13.3 cm in width, leading to a construction rate of 5 m²/hr. At these very fast construction rates, an LLP 25 m in diameter and LLP apron extending an additional 12.5 m composing a 50 m diameter horizontal single-layer structure would take roughly 12.4 Earth days to construct.

The lunar articulating mirror array system may be used to produce a highly concentrated spot on the surface of regolith and translate this spot across the surface at different scan speeds and hatch spacings to produce selectively sintered and melted regolith structures across the surface of the regolith bin. Multiple control strategies may be employed to produce a highly concentrated single spot, a user-specified spot profile such as a spot with an outer ring which is more concentrated than its center, and multiple spots operating independently across the regolith surface. Feedback methods may be evaluated for calibrating the pointing orientation of each mirror element which may include periodic recalibration of the mirrors by diverging the spots to a ring of discrete spots to identify which spot correlates to which mirror element, by a function for minimizing the size of the spot as observed by a CCD camera mounted on the prototype, or by direct monitoring of mirror orientation relative to the body face and common spot location.

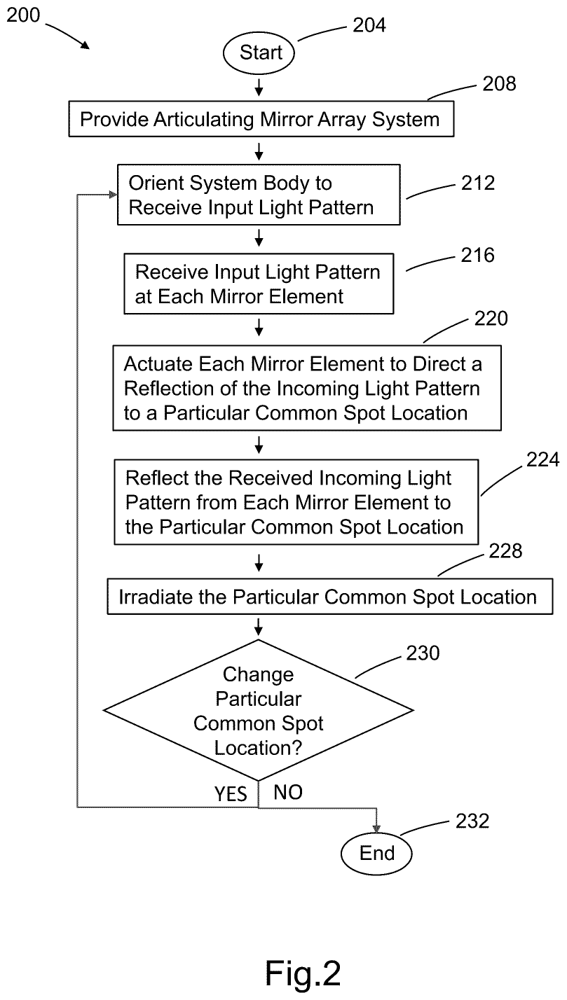

FIG. 2 is a flow chart of a method of use 200 of the lunar articulating mirror array system described above, such as the embodiment of the lunar articulating mirror array system of FIG. 1. Note that some steps of the method 200 may be added, deleted, and/or combined. The steps are notionally followed in increasing numerical sequence, although, in some embodiments, some steps may be omitted, some steps added, and the steps may follow other than increasing numerical order. Any of the steps, functions, and operations discussed herein can be performed continuously and automatically. The method starts at step 204 and ends at step 232.

After starting at step 204, the method 200 proceeds to step 208. At step 208, a lunar articulating mirror array system is provided. The lunar articulating mirror array system may be any of the embodiments described herein or combinations thereof. After completing step 208, the method 200 proceeds to step 212.

At step 212, the system body (and associated mirror array, as coupled to the system body) of the lunar articulating mirror array system is oriented to receive an input light pattern, such as oriented to receive an input light pattern from the Sun. In lunar polar applications, the mirror array of the lunar articulating mirror array system is oriented with minimal to zero elevation. In some embodiments, the system controller of the lunar articulating mirror array system operates to re-orient the mirror array to track the input light pattern, e.g., the track the Sun. After completing step 212, the method 200 proceeds to step 216.

At step 216, the input light pattern is received at each of the mirror elements of the mirror array. (In some embodiments, an optical element may be positioned between the input light source and the mirror array to, e.g., increase the solar concentration of the received input light pattern). After completing step 216, the method proceeds to step 220.

At step 220, the set of actuators associated with each of the set of mirror elements operates (or actuates) to orient each mirror element to a particular common spot location, each mirror element producing an output light pattern of a common focal position at the common spot location. (The particular common spot location may be a selectable common spot location). After completing step 220, the method proceeds to step 224.

At step 224, each mirror element of the mirror array reflects its respective input light pattern to the particular common spot location, the reflected light of a mirror element output light pattern. Each mirror array element output light pattern is of a selectable solar concentration ration with a selectable azimuth angle ϕ and elevation angle θ. After completing step 224, the method proceeds to step 228.

At step 228, the particular common spot location is irradiated by the set of mirror element output light pattern of each of the mirror elements of the mirror array. After completing step 228, the method proceeds to step 230.

At step 230, a query is made as to whether the particular common spot location is to be moved or changed (such as may be the situation when a surface is being created, such as a landing pad). If the response to the query is a YES, the method 200 proceeds to step 212. If the response to the query is a NO, the method 200 proceeds to step 232 and the method 200 ends.

With attention to FIGS. 3A-C, another embodiment of a lunar articulating mirror array system 300 is described. The system 300 of FIG. 3A is very similar to that of system 100, but shown with reduced detail to emphasize optical details of FIGS. 3B-C. The lunar articulating mirror array system 300 comprises a body 310 with a body face 312 and a set of two mirror elements 320A and 320B forming a mirror array attached or coupled or engaged with the body 310 such as the body face 312. The two mirror elements 320A and 320B are separated vertically by a distance D1 and separated horizontally by a distance D2.

Each of the set of mirror elements 320A and 320B operate to receive an input light pattern (such as from the Sun 305) and reflect the input light pattern to produce a mirror element output light pattern of selectable and controllable (by system controller and one or more actuators) orientation. Mirror element 320A receives input light pattern 310A and reflects that light pattern to produce a mirror output light pattern 328A with elevation angle 383A (or θA), azimuth angle 384A (or ϕA), a selectable solar concentration ratio, and a common (common with mirror element 320B) focal position to irradiate common spot location 380. Similarly, mirror element 320B receives input light pattern 310B and reflects that light pattern to produce a mirror output light pattern 328B with elevation angle 383B (or θA), azimuth angle 384B (or ϕA), a selectable solar concentration ratio, and a common (common with mirror element 320A) focal position to irradiate common spot location 380. One or actuators, forming an actuator and mirror element assembly (such as described with respect to FIGS. 6A-D and 7A-B, e.g.), as controlled by system controller effect orientation and otherwise optical character of the output light patterns of each mirror element 320A and 320B.

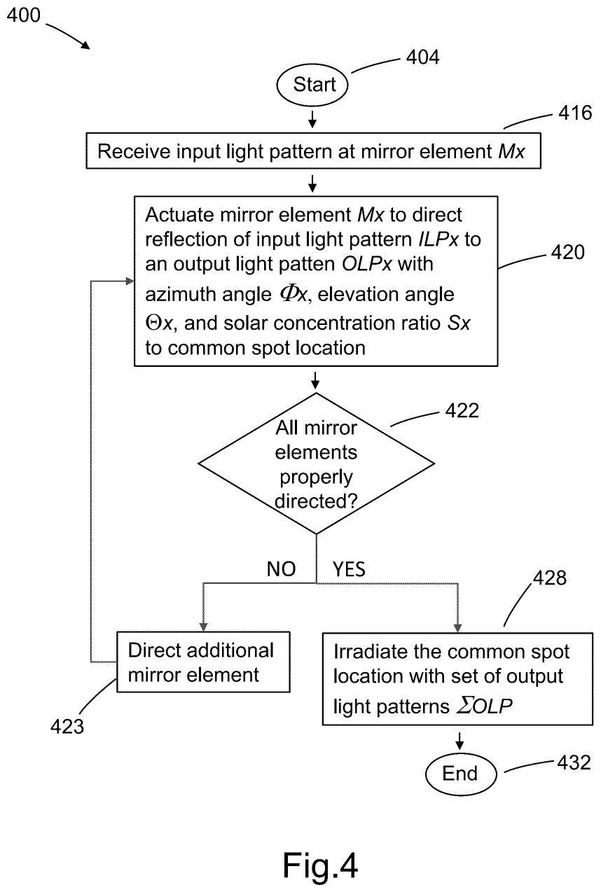

FIG. 4 is a flow chart of a method of use 400 describing additional details of some aspects of the method of use 200 of FIG. 2 of a lunar articulating mirror array system, such as the embodiment of the lunar articulating mirror array system of FIG. 1. Note that some steps of the method 400 may be added, deleted, and/or combined. The steps are notionally followed in increasing numerical sequence, although, in some embodiments, some steps may be omitted, some steps added, and the steps may follow other than increasing numerical order. Any of the steps, functions, and operations discussed herein can be performed continuously and automatically. The method starts at step 404 and ends at step 432.

After starting at step 404, the method 400 proceeds to step 416.

At step 416, an input light pattern, such as may be provided by the Sun, is received at each mirror element Mx, where Mx is a particular mirror element x of a set of n mirror elements. For example, in the system 300 of FIG. 3, n=2, and in the system of FIG. 1, n=4. After completing step 416, the method 400 proceeds to step 420.

At step 420, one or more actuators associated with a particular mirror element Mx operates or actuates to direct a reflection of the input light pattern ILPx of mirror Mx to produce an output light patten OLPx from mirror Mx, the output light pattern OPLx having an azimuth angle ϕx, elevation angle θx, and solar concentration ratio Sx. After completing step 420, the method 400 proceeds to step 422.

At step 422, a query is made as to whether all mirror elements have been properly directed, meaning directed to the common spot location. For example, in the system 300 of FIG. 3, if only the first mirror element 320A has been adjusted but not the second mirror element 320B, then the response to the query would be NO. (Note that in some embodiments, one or more mirror elements may be oriented or positioned simultaneously or near simultaneously). If the response to the query at step 422 is NO, then the method 400 proceeds to step 420. If the response to the query at step 422 is YES, then the method 400 proceeds to step 428.

At step 428, the set of output light patterns ΣOLP from the set of mirror elements Mx are directed to the common spot location to irradiate the common spot location. After completing step 428, the method proceeds to step 432 and the method 400 ends.

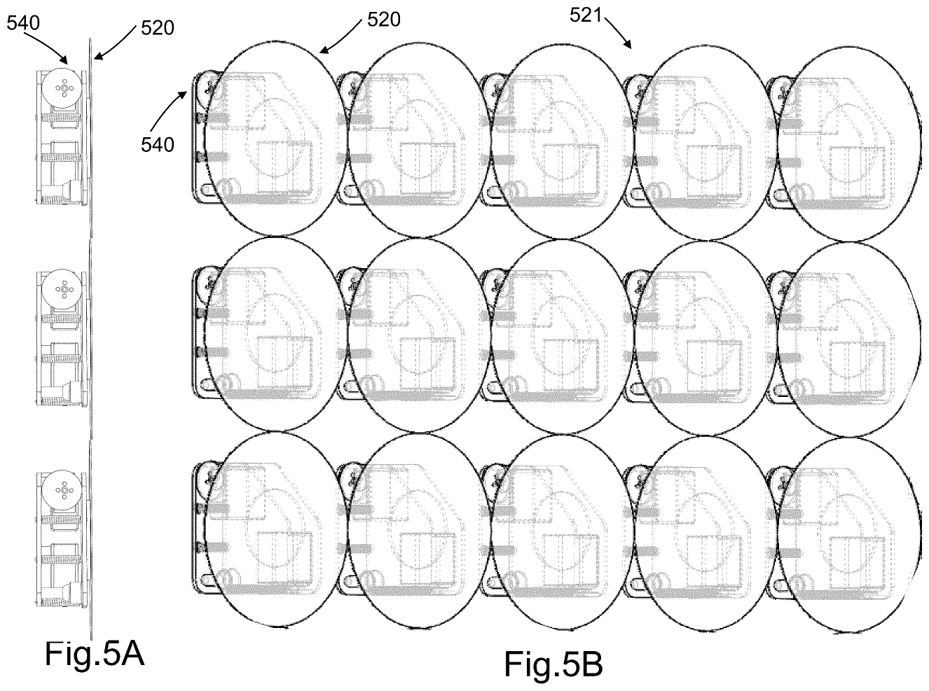

FIGS. 5A-B depict a fifteen mirror element 520 lunar articulating mirror array 521 system in a five by three configuration. The mirror element embodiment of FIG. 5 may be expanded to form a larger mirror array, such as the 900 mirror element array described above, or reduced to form, e.g., the two by two configuration of FIG. 1. The lunar articulating mirror array system as shown in FIGS. 5A-B is composed of an array of independently actuated parabolic mirrors which concentrate and redirect sunlight onto the ground surface. The primary solar concentration of each mirror element and combination of a large number of mirror elements forms a Fresnel solar reflector with a selectable focal position. This unique optomechanical design enables sunlight to be concentrated and transmitted to one or more locations on a fixed surface, and then translated across this surface while maintaining very high concentration ratios, e.g., greater than W/mm². These high solar concentration ratios are capable of inducing liquid-phase sintering of lunar highlands regolith at scan speeds, e.g., greater than 5 mm/s. Large areas of ground may be treated with this method to produce a thin cohesive structure which entrains dust within a stabilized surface, thereby reducing dust that is lofted due to plume-surface interactions or electrostatic levitation. At slower scan speeds of e.g., below 1 mm/s, the high solar concentration ratios produced by LAMA create a molten pool of regolith which forms higher-strength glass-ceramic structures once cooled.

Methods of feedback and control for adjusting the orientation of each mirror element include: 1) open loop control considering concentrator orientation, sun position, and topological data of the construction site, 2) closed loop control utilizing machine vision of the concentrated solar spot to minimize area of the convergent spot produced by the array or to produce a desired spot profile such as an annular ring, and 3) closed loop control utilizing motion capture to determine true rotation of each mirror element relative to the body face and the common spot location. In situ process monitoring of the temperature, phase, and emissions from the molten pool of regolith enables process verification when producing horizontal structures with the LAMA system. Combined, these innovative system and methods produce a robust solar concentrator Fresnel reflector with selectable focal position for lunar surface construction, dust mitigation, and solar-thermal power beaming on the Moon.

FIGS. 6A-D depict one embodiment of an actuator and mirror assembly 629 of the lunar articulating mirror array system. The embodiment addresses, among other design requirements, an ability to provide backlash prevention about each axis of rotation for the mirror elements. Backlash prevention is due to the repeated back and forth motion required when executing a complex scan strategy of a series or set of combined solar spots (so as, e.g., when creating a lunar landing pad). The actuator and mirror assembly 629 provides a mirror mounting and actuation subsystem to enable precise rotation of each mirror element with minimized to no backlash.

The actuator and mirror assembly 629 incorporates 2 axes, tip and tilt, to steer the mirror's focal point to a desired location. An off set ball joint 647 provides a single pivot point about which each axis may rotate. The actuation of each axis is controlled by the system controller by way of a pair of servo motors 641, 643 connected to a respective cam 642, 644 that articulates the mirror plate element 520 as each of the motors 641, 643 actuate to impart a rotation to the respective cam 642, 644 rotated. A set of tension springs 646 (a backlash mitigation device) apply force to the mirror plate 520, keeping the mirror plate 520 in contact with the motor cams 642, 644 and mitigating if not preventing backlash within the subsystem 629. Generally, servo motors are of low cost, repeatable/predictable, and possess control system scalability. In an alternate embodiment, the tip and tilt actuation are driven by thermal actuators or other actuators known to those skilled in the art. The framing (aka structural) components may be, e.g., constructed from aluminum sheet metal component fabricated by laser cutting; such a design is frequently used for the actuation of mirror elements.

In the embodiment of the lunar articulating mirror array system comprising a 10 by 10 m array of 900 mirror elements, a sufficient solar flux density (>1 W/mm²) to selectively melt lunar regolith at distances ranging from 3.5 to 30 m, to selectively melt lunar regolith at distances ranging from 5 to 22.5 m, may be provided, and may easily provide supplemental solar flux to shadowed photovoltaics at ideal concentration ratios.

FIGS. 7A-B depict another embodiment of a lunar articulating mirror array system, the embodiment constructed as a prototype system and employing a “tilt and twist” configuration for the actuator and mirror element assembly. (Note that the mirror surface itself is not shown in FIG. 7B for clarity, but is fitted within void 720′).

A set of four independently actuated parabolic mirrors 720 measuring 8 inches in diameter create a mirror array; the set of mirrors and respective concentrated solar spots are oriented or directed to produce a single combined common solar spot location. The concentrated common solar spot may be translated across a target surface in a scan strategy representative of a selective sintering or melting construction process. Solar power reflected by the prototype array was verified against a Monte-Carlo ray tracing model methodology in terms of both total power and spot size.

The lunar articulating mirror array system 700 comprises a set of four mirror elements 720 each with a mirror surface 726 to form a mirror array 721. Each mirror element 720 is engaged or coupled with a first actuator 741 (which provides a tilt rotation 724 about axis 748) and a second actuator (which provides a twist rotation 722 about axis 749). The second actuator (not shown) is engaged with and operates circumferential (drive) gear (not shown) which in turn engages with mirror rim gear 742. Each mirror element 720 is a parabolic mirror 8 inches in diameter and with a focal length of 2 meters. Each mirror may be actuated about two axes of rotation: a tilt 724 about the mirror's longitudinal direction (i.e., about axis 748) and a twist 722 about the mirror's normal direction (i.e., about axis 749).

Rotation of each mirror 720 about a normal direction may be achieved through a circumferential gear 742 mounted on a rotary bearing of an actuator. The tilt of each mirror was achieved through direct drive by a NEMA 17 motor (i.e., the actuator 741) and an opposing torsion spring (a backlash mitigation device) to prevent backlash. Twist was achieved through a NEMA 17 5:1 geared stepper motor powering a circumferential gear upon which the mirror and tilt assemblies are mounted.

The four independently actuated mirrors 720 are mounted in a planar assembly to the body face of the body of the lunar articulating mirror array system 700. The planar assembly, as mounted on the body structure, has two degrees of actuation. The main system body structure may be rotated about the azimuthal axis of the system body. Manual angle adjustments of the mirror array relative to solar location may be made with the guidance of a laser cut tilt guide. In one embodiment, the tilt of the mirror array 721 was set to 22.5° below the horizon.

In prototype, testing, the planar assembly of the set of four mirrors was oriented at 22.5° from a horizontal target surface and the orientation of each mirror was driven about the respective 2 degree of freedom until the concentrated solar spots produced by the four mirrors converged at a common point on a receiver surface. The power transmitted by this combined array was measured at 95 Watts which corresponded to an overall optical efficiency of more than 85% for the mirror array. The profile of the spot was imaged and the average solar flux density produced by this LAMA prototype was calculated to be 9.5 W/cm² across the approximately 10 cm² spot. The convergent concentrated solar spot was then moved to three different locations on the receiver target spaced approximately 10 inches apart. The orientation of each mirror was then controlled between these three target locations to demonstrate the ability to translate a highly concentrated solar spot across a fixed surface at controlled speeds.

Generally, experimental results verified the control of multiple solar concentrating mirrors to produce a highly concentrated solar spot and translate such a solar spot across a fixed surface in a scan strategy representative of a selective solar melting or sintering process. Additionally, a concentrated solar energy with flux density>1 W/mm² may be used to produce two different regolith surface structures: 1) a fully melted single- or multi-layer structure of consolidated glass-ceramic material with high compressive strength and fracture toughness, the the bearing strength of single- and multi-layer selectively solar melted structures as a function of specimen thickness, and 2) a thin, liquid-phase sintered regolith layer bonding grains within a stabilized surface structure, with the resulting percent reduction being a 92% reduction in ejecta mass as compared to untreated control specimens when exposed to a 3 second burst of 120 psi air and approximate wind speed of 12 m/s.

Structures produced with concentrated solar energy were evaluated through non-destructive and destructive tests which showed that the selectively solar melted material exhibits strengths greater than standard concrete and that a 3.2 cm thick landing pad made from this material is capable of withstanding the vertical loads that would be applied by the footpad of a human rated lander weighing more than 1,000 metric tons. The selectively solar liquid-phase sintered surface was shown to resist viscous erosion forces when exposed to a pressurized gas, and reduced the mass of ejecta by up to 92% as compared to an untreated regolith surface.

In some embodiments, the lunar articulating mirror array may construct a 50 m diameter LLP in less than 12.7 days. A 9 m² LAMA may construct an LLP similar in size as the MMPACT DM-2 (25 ft in diameter) in less than 2.7 days. Dust mitigation testing indicated that an initial step of compacting the regolith may not be required for achieving an effective dust mitigation treatment. LAMA may produce single layer LLPs for autonomous lunar landers with no site preparation required to increase the modulus of subgrade reaction. LAMA may construct a single layer LLP for large, manned landers with accompanying site preparation.

In one embodiment, a lunar articulating mirror array redirects solar radiation using a masted heliostat array with a solar collector area measuring approximately 100 m². The face of the array is composed of articulating parabolic concentrating mirrors to form a variable focal length Fresnel reflector. The mast and array may be mounted on a lunar rover such as the NASA All-Terrain Hex-Limbed Extra-Terrestrial Explorer (ATHLETE) or other mobility system developed for the lunar environment. The system concentrates 130 kW of solar energy and fully melts or sinters a surface of regolith. The mirror articulation allows for the array to translate a concentrated solar spot across a horizontal regolith surface and produce a molten regolith pool from distances of between 3.5 m to 30 m from the array. Also, sunlight may be concentrated and projected at greater than 85% optical efficiency to one or more locations on the lunar surface at very high concentration ratios (>1,000 suns). This configuration of LAMA fuses regolith to form a cohesive layer ranging from a dendritic surface structure to a thick consolidated layer of regolith with strength greater than concrete. These activities are performed by LAMA at a distance of meters to tens of meters from the construction, require no binders or other consumables from Earth, require minimal to no site preparation prior to construction, and require only nominal levels of electrical power by instead relying on the abundant solar power on the Moon to drive the solar-thermal heating, melting, and fusing of regolith structures enables high solar flux densities (greater than 1 W/mm²) to be concentrated onto a spot several meters to tens of meters from the solar concentrating array. Also, the impact of dust on the optics is minimized due to their vertical orientation and elevated position above the ground surface.

Note that other methods of use of the disclosed lunar articulating mirror array system are possible. Alternate methods of use include power generation through the concentration of light onto photovoltaics or a solar-thermal electrical power generator. Also, any of the steps, functions, and operations discussed herein can be performed continuously and automatically. In some embodiments, one or more of the steps of the method of use may comprise computer control, use of computer processors, and/or some level of automation.

The exemplary systems and methods of this disclosure have been described in relation to systems and methods involving a lunar articulating mirror array system for precise and controlled operations involving lunar regolith. However, to avoid unnecessarily obscuring the present disclosure, the preceding description omits a number of known structures and devices, and other applications and embodiments. This omission is not to be construed as a limitation of the scope of the claims. Specific details are set forth to provide an understanding of the present disclosure. It should however be appreciated that the present disclosure may be practiced in a variety of ways beyond the specific detail set forth herein.

A number of variations and modifications of the disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An articulating mirror array system comprising:
a body comprising a body face;
a set of mirror elements forming a mirror array, each mirror element attached to the body face and configured to receive an input light pattern and reflect the input light pattern to produce a mirror element output light pattern;
a set of mirror actuators, each mirror actuator configured to articulate a respective mirror element about at least one axis to direct the respective mirror element output light pattern to a common spot location;
a body actuator configured to articulate the body about at least one axis;
a processor; and
a controller in communication with the processor and configured to control the body actuator, the set of mirror actuators, and a selectable solar concentration ratio of each mirror element output light pattern;
wherein:
the controller controls the set of mirror actuators to articulate the respective mirror element to direct the respective mirror element output light pattern with an azimuth angle, an elevation angle, and a solar concentration ratio to the common spot location;
the controller controls the set of mirror actuators to produce a set of mirror output light patterns, each mirror element light pattern having a common focal position at the common spot location; and
the common spot location is irradiated by the set of mirror output light patterns.

2. The articulating mirror array system of claim 1, further comprising a body mast coupled to the body and configured to position the body at a selected elevation above the ground.

3. The articulating mirror array system of claim 1, wherein the body actuator operates to articulate the mirror array to track the input light pattern.

4. The articulating mirror array system of claim 1, wherein the input light pattern is provided by the Sun and the mirror elements are parabolic mirrors.

5. The articulating mirror array system of claim 1, wherein the set of mirror actuators comprise at least two mirror actuators for each mirror element that operate to rotate each mirror element about a local mirror element horizontal axis.

6. The articulating mirror array system of claim 1, wherein the common spot location enables at least one of sintering and power generation.

7. The articulating mirror array system of claim 1, further comprising a body sensor coupled to the body, the body sensor measuring at least one of an input solar irradiance of the input light source and a location of the input light source.

8. The articulating mirror array system of claim 1, further comprising a common spot location sensor positioned adjacent the common spot location and measuring at least one of a common spot location temperature, a common spot location focal spot shape, a common spot light intensity distribution, and a phase change of material.

9. The articulating mirror array system of claim 1, further comprising a set of backlash mitigation devices, at least one backlash mitigation device engaged with each mirror element of the set of mirror elements and operating to prevent backlash of the mirror element during mirror actuator operation.

10. A method of using an articulating mirror array system, the method comprising:
providing an articulating mirror array system comprising:
a body comprising a body face;
a set of mirror elements forming a mirror array, each mirror element attached to the body face and configured to receive an input light pattern and reflect the input light pattern to produce a mirror element output light pattern;
a set of mirror actuators, each mirror actuator configured to articulate a respective mirror element about at least one axis to direct the respective mirror element output light pattern to a common spot location;
a body actuator configured to articulate the body about at least one axis;
a processor; and
a controller in communication with the processor and configured to control the body actuator, the set of mirror actuators, and a selectable solar concentration ratio of each mirror element output light pattern;
orienting the body to receive the input light pattern;
receiving the input light pattern at each of the set of mirror elements;
actuating, by the controller, each of the set of mirror actuators to articulate the respective mirror element to direct the respective mirror element output light pattern with an azimuth angle, an elevation angle, and a solar concentration ratio to the common spot location;
controlling, by the controller, the set of mirror actuators to produce a set of mirror output light patterns, each mirror element light pattern having a common focal position at the common spot location; and
irradiating the common spot location by the set of mirror output light patterns.

11. The method of claim 10, further comprising the step of tracking the input light pattern with the mirror array by actuating the body actuator as the input light pattern changes source position.

12. The method of claim 10, further comprising a sensor placed adjacent the common spot location to monitor at least one of a common spot position, a solar flux density distribution, a common spot light intensity distribution, a temperature, and a phase change of material.

13. The method of claim 10, wherein the input light pattern is provided by the Sun.

14. The method of claim 10, wherein the mirror elements are parabolic mirrors.

15. The method of claim 10, wherein the common spot location enables at least one of sintering and power generation.

16. The method of claim 10, wherein the set of mirror actuators comprise at least two mirror actuators for each mirror element that operate to rotate each mirror element about a local mirror element horizontal axis.

17. The method of claim 10, further comprising a set of backlash mitigation devices, at least one backlash mitigation device engaged with each mirror element of the set of mirror elements and operating to prevent backlash of the mirror element during mirror actuator operation.

18. The method of claim 10, further comprising a body mast coupled to the body and configured to position the body at a selected elevation above the ground.

19. The method of claim 10, further comprising a body sensor coupled to the body, the body sensor measuring at least one of an input solar irradiance of the input light source and a location of the input light source.

20. An articulating mirror array system comprising:
a body comprising a body face;
a set of mirror elements forming a mirror array, each mirror element coupled to the body face and configured to receive an input light pattern and reflect the input light pattern to produce a mirror element output light pattern;
a set of mirror actuators, each set of mirror actuators configured to articulate a respective mirror element about at least one axis to direct the respective mirror element output light pattern to a common spot location;
a set of backlash mitigation devices, at least one backlash mitigation device engaged with each mirror element of the set of mirror elements;
a body actuator configured to articulate the body about at least one axis;
a processor; and
a controller in communication with the processor and configured to control the body actuator, the set of mirror actuators, and a selectable solar concentration ratio of each mirror element output light pattern;
wherein:
the input light pattern is provided by the Sun;
the mirror elements are parabolic mirrors;
the set of mirror actuators comprise at least two mirror actuators for each mirror element that operate to rotate each mirror element about a local mirror element horizontal axis;
the set of backlash mitigation devices prevent backlash of each of the mirror elements during mirror actuator operation;
the controller controls the set of mirror actuators to articulate the respective mirror element to direct the respective mirror element output light pattern with an azimuth angle, an elevation angle, and a solar concentration ratio to a common spot location;
the controller controls the set of mirror actuators to produce a set of mirror output light patterns, each mirror element light pattern having a common focal position at the common spot location; and
the common spot location is irradiated by the set of mirror output light patterns.
